(19) United States
(12) Patent Application Publication
(10) Pub. No.: US 2011/0080021 A1
(43) Pub. Date: Apr. 7, 2011

(54) Quick Mounting for Protective Plates for Vehicles

(76) Inventors: Mark Steven Crosson, Olympia, WA (US); Lorna Beatrice Crosson, Olympia, WA (US)

(21) Appl. No.: 12/575,390

(22) Filed: Oct. 7, 2009

(51) Int. Cl. B62D 23/00

(52) U.S. Cl. 296/191; 296/35.1

(57) ABSTRACT

Using multiple hook-type anchor bolts the user can quickly mount and remove a protective plate on or under vehicles by hooking onto the frame and/or parts of the body of the vehicle. Hook-type anchor bolt mounting avoids costly, labor-intensive, complex, and risky drilling into the body and/or frame of the vehicle as required by conventional mounting process requiring bolt holes to be drilled into the frame and/or body of the vehicle and secured by bolts. With this new method of mounting a protective plate the user can mount or remove a protective plate in a few minutes instead of taking 2 hours or more. This new method also avoids the need to disassemble parts of the vehicle to drill the mounting holes in remote locations on the frame and/or body of the vehicle.

### BACKGROUND OF THE INVENTION

Farm equipment, utility vehicles, recreational vehicles, two, three or four wheeled vehicles, and vehicles using tank type tracks will use this product design improvement. This design improvement allows the quick secure mounting of protective plates made of metal and/or synthetic materials.

Typically protective plates are mounted by precise drilling of holes in the body and/or frame of the vehicle. Often these holes need to be drilled in very tight and rather inaccessible places. Sometimes the vehicle must be partially disassembled to ensure proper placement of a mounting hole. If a hole is accidentally drilled in the wrong place it may result in damage and expensive repairs or at the very least additional installation time and expense.

This design method uses a combination of anchor bolts, like those used in concrete foundations, mounting the building's walls to the foundation. Because of mass production to support another industry, anchor bolts are extremely inexpensive in comparison to machined parts.

This design method uses anchor bolts as hooks to hook the protective plate to the vehicles frame. Hooking the plate to the frame eliminates the need for drilling holes. Hooking the plate to the frame also allows the secure mounting a removal of the protective plate in a few minutes in place of the 2-3 hours for conventional methods.

Though we did not find any protective plates using u-type bolts mounting, to use this type of mounting would require full clearance to all sides of the frame. This type of mounting would require significant vehicle disassembly. Please refer to the DRAWINGS section, page 6, for additional information.

The Inventors purchased a new farm tractor costing many thousands of dollars. Within the first few hours of operation the user ran over very small diameter sticks protruding from the ground. One of these sticks popped up under the tractor into an internally mounted plastic fan, quickly destroying the fan. The replacement fan costs under $6 to purchase. The labor to install the fan costs more than $600 because the engine and/or transmission must be removed. The inventors, wanting to avoid a repeat of this expensive event and loss of the use of the tractor for extended periods so the inventors conducted an extensive search of the tractor, vehicle and equipment dealers and manufactures and could only find one type of protective product. The conventional method is a fixed mounted protective plate that requires precise drilling of holes in the vehicles frame and the use of a half dozen bolts and nuts for mounting. The manufacturer indicated that it would take approximately 2 hours to install. Several customers' comments related to the conventional protective plate taking more than 2-3 hours to install and if they had drilled the holes in the wrong places the result costing hundreds of dollars to repair. The process for the current method of attaching a protective plate was so difficult that several vehicles owners indicated that they gave up and took their vehicle to a mechanic and paid hundreds of dollars for the installation of a protective plate using a conventional attachment method, or gave up entirely on the installation of the protective plate. Our local vehicle maintenance facility charges an additional $125 to remove and replace the conventional protective plates in order to perform regular maintenance. Protective plates must be removed regularly to access filters and electronics for frequent maintenance.

Though we did not find any protective plates using u-type bolts mounting, to use this type of mounting would require full clearance to all sides of the frame. This type of mounting would typically require significant vehicle disassembly.

### BRIEF DESCRIPTION OF DRAWINGS

The accompanying drawings illustrate the invention.

In such drawings:

FIG. 1 is a typical side view of the invention showing the hook-type anchor bolts the mounting nuts and washers (A), protective plate (B), and the curve/angle of the anchor bolt that increases the effectiveness of the attachment (C).

FIG. 2 is a typical top view of the invention showing the flanges in which the holes are drilled to attach the protective plate (B) the vehicle frame (D). The attachment holes can be drilled directly into the protective plate without the use of flanges depending on the specific application.

FIG. 3 is a typical front view of the invention showing the hook-type anchor bolts (A), the protective plate (B), the vehicle's frame (E), and the lock-nuts and washers used with the bolts to attached the protective plate (F). Multiple hook-type bolts are used as required by the specific application.

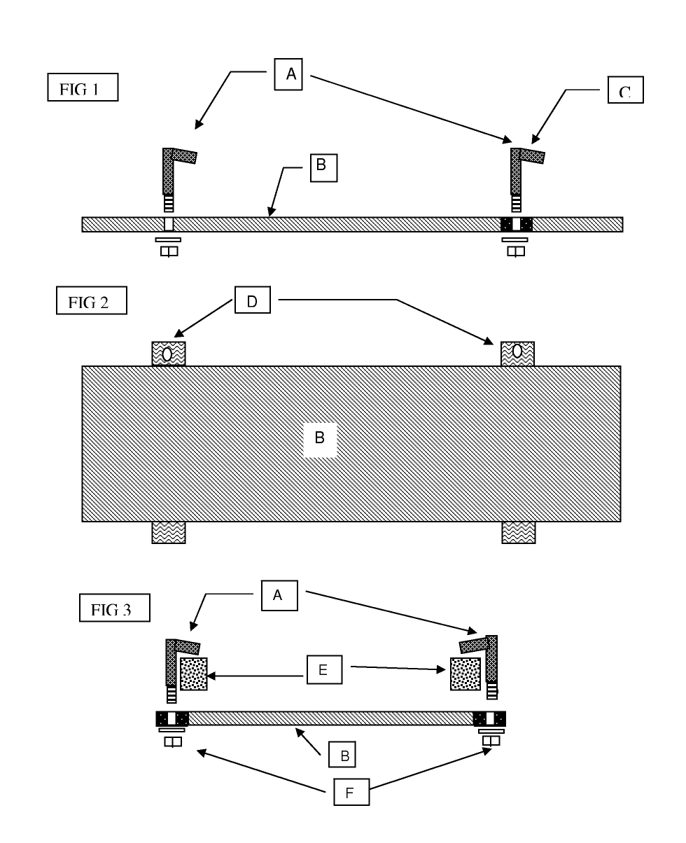

What is claimed is:

1-5. (canceled)

6. The apparatus consists of a protective plate design with holes drilled in locations to allow the secure attachment to the frame and/or body of a vehicle by using multiple anchor hook-type bolts and lock-nuts. Please refer to the drawings on page 6 for more information.

7. The apparatus of claim 6 wherein by designing a method of attaching protective plates without drilling holes in the frame and/or body of the vehicle or altering the vehicles frame or body. By avoiding drilling holes, the inventors have created a process by which the method of attaching the protective plate adds to the strength of the vehicle frame instead of compromising it, like conventional attachment methods do by requiring the drilling of holes in the vehicle's frame.

8. Wherein using a hooking type attachment avoids the requirement to use precisely drilled holes in the vehicle's frame. The inventor can use one protective plate design for many different vehicles making the production and distribution of protective plates much more cost effective.

9. The apparatus of claim 8 wherein drilling holes in a vehicles frame can seriously weaken the frame of a vehicle and could compromise the vehicle's warranty. Please refer to the drawings on page 6 for more information.

10. Wherein the apparatus uses very inexpensive anchor hook-type bolts mass-produced for the building construction industry for mounting stem walls into concrete foundations. Using mass produced materials significantly reduces the cost of building the apparatus. Please refer to the drawings on page 6 for more information.
